(19) United States
(12) Patent Application Publication
(10) Pub. No.: US 2023/0099450 A1
(43) Pub. Date: Mar. 30, 2023

(54) DEVICE FOR TREATING ALGAE IN WATERS OF INTEREST USING HIGH-VOLTAGE MICRO PULSE DISCHARGE

(71) Applicant: SUN & SEA CO., LTD., Anyang-si, Gyeonggi-do (KR)

(72) Inventors: Chul-yeong KIM, Gunpo-si, Gyeonggi-do (KR); Heesung LEE, Seoul (KR); Youngseong LIM, Changwon-si, Gyeongsangnam-do (KR); Gil Hwan CHOI, Anyang-si, Gyeonggi-do (KR)

(73) Assignee: SUN & SEA CO., LTD., Anyang-si, Gyeonggi-do (KR)

(21) Appl. No.: 17/802,961

(22) PCT Filed: Feb. 24, 2021
(86) PCT No.: PCT/KR2021/002296

§ 371 Date: Aug. 28, 2022

(30) Foreign Application Priority Data
Mar. 17, 2020 (KR) 10-2020-0032355

(51) Int. Cl. C02F 1/46; C02F 1/52; C02F 1/40

(52) U.S. Cl. CPC C02F 1/4608; C02F 1/52; C02F 1/40; C02F 2201/008; C02F 2103/007

(57) ABSTRACT

An algae treatment device of the present invention is installed in a ship or a barge and selectively destroys only the air-sacs of algae by discharging high-voltage micro pulses into waters of interest in which green tide or red tide has occurred. Thus, the algae treatment device can efficiently solve green tide or red tide by treating algae using a minimal amount of chemicals, or none at all.

### TECHNICAL FIELD

The present invention relates to a device for treating algae in waters of interest, and more particularly, to a device capable of treating algae that is excessively generated in waters of interest by discharging high-voltage micro pulses into the waters of interest.

### BACKGROUND ART

Green tide or red tide represents a phenomenon in which a color of water is changed into dark green or red due to overgrowth of algae (diatoms, green algae, blue-green algae), which is a component of supplying energy to an aquatic ecosystem.

In a place in which the green tide or the red tide occurs, an odor is generated, or dissolved oxygen (DO) decreases to cause ecosystem destruction that threatens aquatic organisms. Furthermore, harmful algae such as microcystis, anabena, oscillatoria, and apanizomenon gives a harmful effect on an interstitial cell and a nervous system when a person or an animal absorbs the algae.

Although a method of spraying copper sulfide, aluminum oxide, titanium dioxide, or red clay to a river or a method of removing the algae is typically used to solve the green tide or the red tide, the above-described method requires excessive manpower or has a risk of secondary pollution. Also, the method of spraying copper sulfide, aluminum oxide, titanium dioxide, or red clay to a river requires a pH of 7 to 8 to smoothly treat the green tide or the red tide. However, when the green tide or the red tide occurs in a river, the river is changed into alkalinity, and a removing efficiency is significantly degraded.

Thus, a new method for treating the green tide or the red tide occurring in waters of interest such as a river, a reservoir dam, a water treatment facility, or nearby sea is demanded.

### DISCLOSURE OF THE INVENTION

### Technical Problem

The present invention provides a treatment device capable of actively solving green tide or red tide through high-voltage micro pulse discharge by using a minimal amount of chemicals or none at all in waters of interest such as a river, a reservoir, a dam, a water purification plant, and nearby sea.

Also, other objects of the present invention, which are not specified herein, will be further considered within the scope of being easily inferred from the following detailed description and effects thereof.

### Technical Solution

In order to achieve the objects, an embodiment of the present invention provides an algae treatment device, which treats algae generated excessively in waters of interest, installed on a ship or a barge to discharge a high-voltage micro pulse, thereby treating algae in the waters of interest. The algae treatment device includes: a pulse generation unit for generating a high-voltage micro pulse; at least one front end connected with the pulse generation unit to discharge the generated high-voltage micro pulse into the waters of interest; and a support frame on which a front end wire configured to connect the front end and the pulse generation unit is held and which allows the front end to maintain a predetermined depth in the waters of interest.

In order to achieve the objects, another embodiment of the present invention provides an algae treatment device including: a ship or a barge; a support frame including a buoyant body to move depending on movement of the ship or the barge on water of waters of interest; a connection member configured to connect the ship or the barge with the support frame; a pulse generation unit installed on the ship or the barge; and at least one front end installed on the support frame and connected with the pulse generation unit to discharge a generated high-voltage micro pulse into the waters of interest.

### Advantageous Effects

The algae treatment device according to one embodiment of the present invention exhibits following effects in the waters of interest, in which the algae is excessively generated.

First, the algae treatment device may selectively destroys the air-sac of the algae by discharging the high-voltage micro pulse at one position or while moving in the waters of interest by using the ship, the barge, or the buoyant body. That is, the algae treatment device may remove the algae by using the minimal amount of chemicals such as copper sulfide, aluminum oxide, or titanium dioxide, or none at all. Also, the algae treatment device may remove the algae in the wide range of waters of interest while moving with the minimum manpower.

Second, the algae treatment device may include the replaceable positive electrode and negative electrode of the front end to effectively cope with the wear of each of the positive electrode and the negative electrode caused by the tens of thousand micro pulse discharges per one day in the process of removing the algae.

Third, the algae treatment device may include the separate front end lifting unit disposed on the support frame to easily replace the positive electrode or the negative electrode by lifting the front end when the positive electrode or the negative electrode of the front end is replaced.

Here, although effects are not explicitly mentioned herein, effects described in the following specification and expected by the technical features of the present invention and potential effects thereof are treated as described in the specification of the present invention.

### BRIEF DESCRIPTION OF THE DRAWINGS

FIG. 1 is a schematic perspective view of an algae treatment device according to a first embodiment of the present invention, in which the algae treatment device is installed on a barge.

FIG. 2 is a schematic perspective view of an algae treatment device according to a second embodiment of the present invention, in which the algae treatment device is installed on a ship.

FIG. 3 is a schematic perspective view of an algae treatment device according to a third embodiment of the present invention, in which the algae treatment device moves by using a ship on which a buoyant body is installed.

FIG. 4 is a schematic configuration diagram of a drinking water treatment system in which an algae treatment device according to another embodiment of the present invention is installed.

FIG. 5 is a photograph showing the drinking water treatment system in which the algae treatment device according to another embodiment of the present invention is installed.

FIG. 6 is a schematic circuit diagram showing a configuration of the algae treatment device according to the present invention.

FIG. 7 is a schematic graph showing a waveform of a high-voltage micro pulse generated by the algae treatment device according to the present invention.

FIG. 8 is a schematic perspective view of a front end of the algae treatment device according to the present invention.

FIG. 9 is schematic cross-sectional view taken along line I-I′ of FIG. 8.

FIG. 10 is an exploded cross-sectional view of a positive electrode shaft, a positive electrode chuck, and a positive electrode of the algae treatment device according to the present invention.

FIG. 11 is a schematic cross-sectional view of a negative electrode of the front end of the algae treatment device according to the present invention.

FIG. 12 is a graph obtained by measuring pressure generated based on a distance when the high-voltage micro pulse is discharged in water by using the algae treatment device according to the present invention.

FIG. 13 is an image in which the front ends of the algae treatment device according to the present invention are alternately arranged.

FIG. 14 is a photograph showing an experiment result obtained by discharging the high-voltage micro pulse into water containing algae by using the algae treatment device according to the present invention.

FIG. 15 is a SEM photograph of an algae cell before and after the high-voltage micro pulse is discharged into the water containing the algae by using the algae treatment device according to the present invention.

FIG. 16 is a TEM photograph of an algae cell before and after the high-voltage micro pulse is discharged into the water containing the algae by using the algae treatment device according to the present invention.

The attached drawings are presented for purposes of explanation only, and the technical scope of the present invention is not limited thereto.

### MODE FOR CARRYING OUT THE INVENTION

Hereinafter, features of the present invention and effects thereof according to various embodiments will be described with reference to the accompanying drawings. In the following description of the present invention, a detailed description of known functions and configurations which are obvious to those skilled in the art will be omitted when it may unnecessarily make the subject matter of the present invention rather unclear.

The present invention relates to a treatment device capable of actively solving green tide or red tide through high-voltage micro pulse discharge by using a minimal amount of chemicals or none at all in waters of interest such as a river, a reservoir, a dam, a water purification plant, and nearby sea.

Hereinafter, configurations, operations, and effects of an algae treatment device according to the present invention will be described with reference to the accompanying drawings.

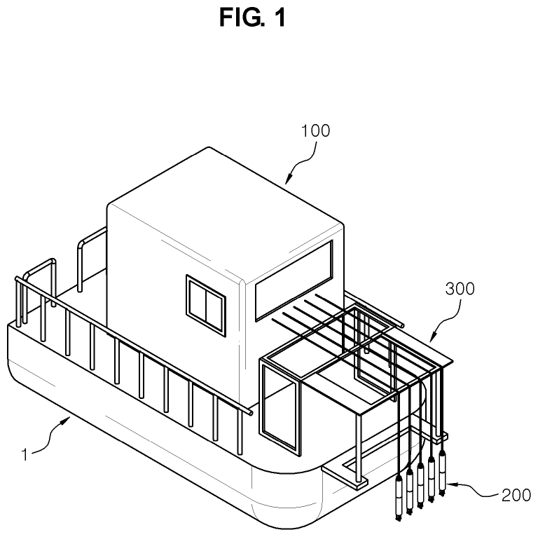

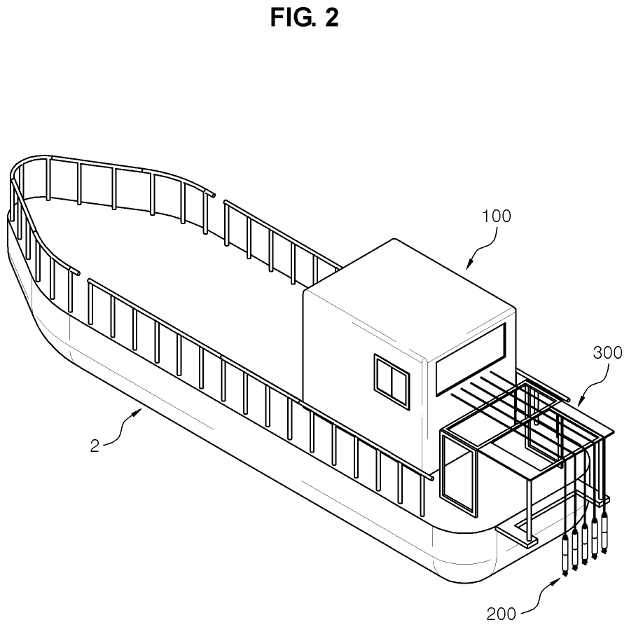

FIG. 1 is a schematic perspective view of an algae treatment device according to a first embodiment of the present invention, and FIG. 2 is a schematic perspective view of an algae treatment device according to a second embodiment of the present invention. In FIGS. 1 and 2, the algae treatment device is installed on a ship.

The algae treatment device according to the present invention includes a pulse generation unit 100, a front end 200, and a support frame 300. The algae treatment device is intended to treat algae in waters of interest by discharging high-voltage micro pulses into the waters of interest. Also, the algae treatment device may include a generator for generating power, a compressor, and a temperature control device. The generator generates electric power supplied to the algae treatment device, and the temperature control device prevents the algae treatment device from being overloaded. The compressor supplies compressed air when a switch of the algae treatment device according to the present invention operates by pneumatic pressure. However, when the switch operates in a different method, the compressor may be omitted.

FIG. 1 illustrates a state in which the algae treatment device according to the present invention is installed on a barge 1, and FIG. 2 illustrates a state in which the algae treatment device according to the present invention is installed on a ship 2.

According to the present invention, the algae treatment device is installed on the barge 1 or the ship 2 and discharges high-voltage micro pulses while the barge 1 or the ship 2 moves in the waters of interest or moves to and then is anchored at one position.

The pulse generation unit 100 for generating the high-voltage micro pulses is installed on the barge 1 or the ship 2 and connected to at least one front end 200. At least one end of the front end 200 is submerged into the waters of interest. The pulse generation unit 100 and the front end 200 will be described in detail later.

The front end 200 is fixed to the support frame 300. The support frame 300 installed on the barge 1 or the ship 2 may have a protruding part configured such that one side of the support frame 300 extends and protrudes to the outside of the barge 1 or the ship 2. A cable that connects the pulse generation unit 100 and the front end 200 is held by the protruding part of the support frame 300, and the front end 200 is disposed on a lower end of the protruding part. The cable is fixed to the support frame 300 by using a separate fixing member.

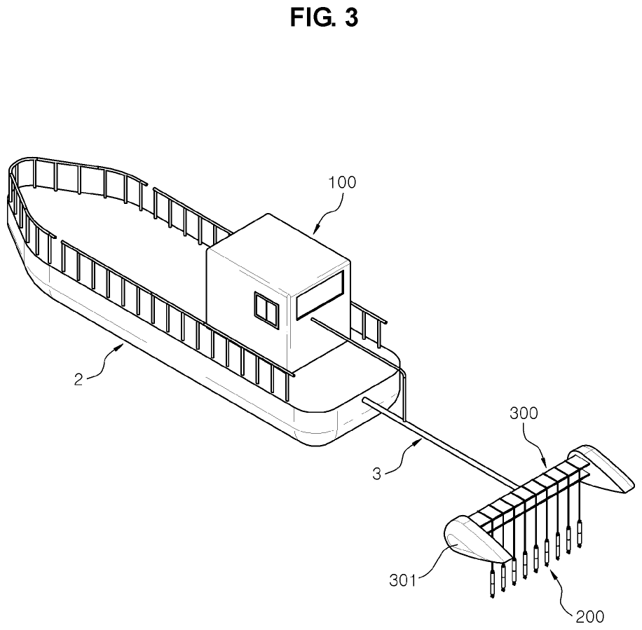

FIG. 3 is a schematic perspective view of an algae treatment device according to a third embodiment of the present invention, in which the algae treatment device moves by using a ship on which a buoyant body is installed.

FIG. 3 illustrates a state in which a buoyant body 301 is installed on a support frame 300 unlike the first embodiment or the second embodiment.

The pulse generation unit 100 is installed on a barge 1 or a ship 2 like the first embodiment or the second embodiment. The support frame 300 on which the buoyant body 301 is installed is connected to a stern of the barge 1 or the ship 2 by a connection member 3. When the barge 1 or the ship 2 moves, the support frame 300 is dragged by the connection member 3. In comparison with a case of using only the barge 1 or the ship 2, a case of using the support frame 300 may discharge high-voltage micro-pulses into a wider area and particularly expand the area in front and rear directions as well as left and right directions.

Unlike as described above, the algae treatment device according to the present invention may be installed and used in a drinking water treatment facility.

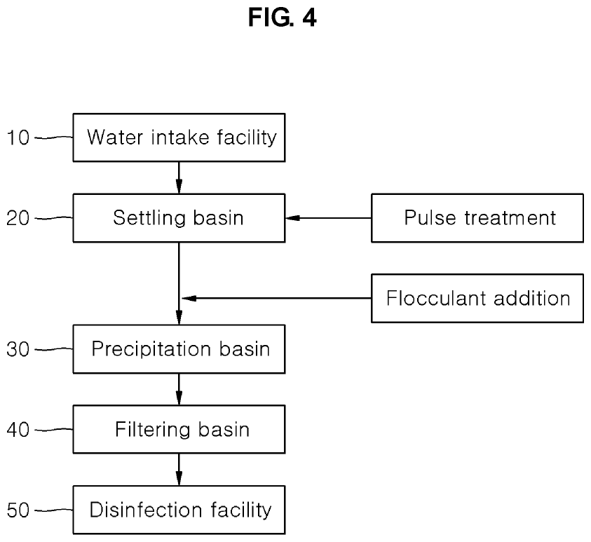

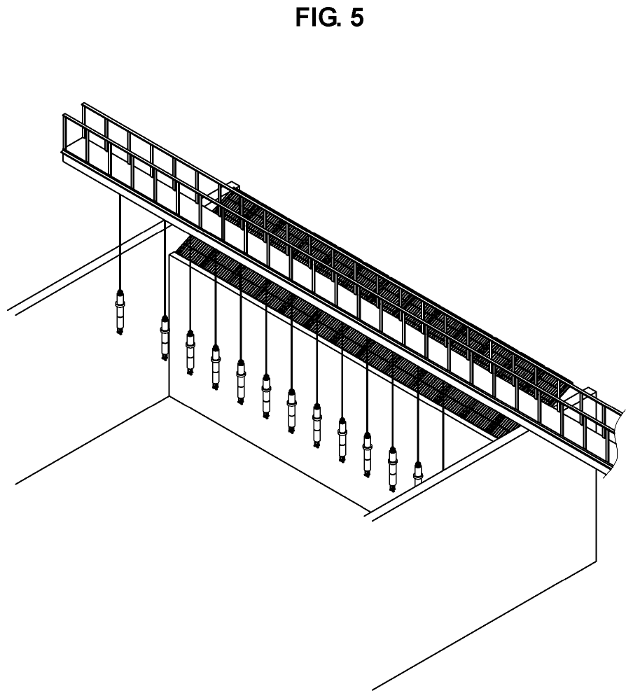

FIG. 4 is a schematic configuration diagram of a drinking water treatment system in which an algae treatment device according to another embodiment of the present invention is installed, and FIG. 5 is a photograph showing the drinking water treatment system in which the algae treatment device according to another embodiment of the present invention is installed.

Flocculant (aluminum oxide, etc.) is used to remove algae in a water treatment facility. When green tide occurs, an amount of the used flocculant significantly increases. The increase in the amount of used chemicals such as the flocculant is one problem, and another problem is that a flocculation reaction does not occur smoothly at an alkaline PH although a large amount of flocculant is added because a PH of water is changed from neutral to alkaline when the green tide occurs, and a pH at which the coagulation reaction occurs smoothly (hereinafter, referred to as a ‘flocculant pH’) is about 7 to about 8. Thus, an added amount of a used pH adjuster (carbon dioxide, etc.) also increases in addition to the amount of the flocculant to reduce the pH of water. The algae is removed by the flocculant, and then remained algae is removed by chlorine treatment. Here, when the green tide occurs, an amount of added chlorine also increases. Furthermore, management and maintenance costs of a sand layer (filter sand) and activated carbon, which are added to remove the remained algae, increase even in a filter bed.

To solve the above-described problem, the algae treatment device according to the present invention may be installed and used in the drinking water treatment system.

In the drinking water treatment system, precipitation of the algae by discharging the high-voltage micro pulses in the drinking water treatment system is performed in a first treatment space, and the flocculation reaction of the algae by adding the flocculant is performed in a second treatment space. Preferably, the first treatment space may be a settling basin, and the second treatment space may be a precipitation basin However, the present invention is not limited thereto. For example, the first treatment space and the second treatment space may be arbitrary spaces distinguished in terms of a function in the drinking water treatment system.

The drinking water treatment system according to the present invention includes a water intake facility 10, a settling basin 20, a precipitation basin 30, a filtering basin 40, and a disinfection facility 50.

The water intake facility 10 that draws raw water from a river or a reservoir for supplying tap water and supplies the drawn water to the water treatment facility includes a water intake tower, a water intake door, and a water intake pipe. The water drawn to the water intake facility is introduced to the settling basin 20.

Soil is mixed with the raw water drawn from a river, a reservoir, and a stream, and the settling basin 20 is a space of removing the soil from the raw water by using a precipitation method. The settling basin 20 includes the algae treatment device according to the present invention in order to cope with the green tide and discharge upper water after the algae contained in the introduced raw water is precipitated by discharging the high-voltage micro pulses.

When the raw water is introduced into the settling basin 20, the algae treatment device precipitates the algae by destroying an air-sac of the algae contained in the raw water and then discharges upper water. The upper water is introduced to the precipitation basin 30 together with the remained algae.

The precipitation basin 30 precipitates the remained algae and floating materials contained in the upper water by adding the flocculant. Although the flocculant may be directly added to the precipitation basin 30, preferably, a precipitation reaction may be induced in the precipitation basin 30 by adding the flocculant before the upper water is introduced into the precipitation basin 30. For example, the flocculant is a material obtained by combining aluminum hydroxide (Al(OH)₃) with silicon (Si) and operates based on a principle in which aluminum reacts with the algae and is sunken in water. In addition, any well-known flocculant may be used.

In general, the flocculation reaction caused by the flocculant does not occur smoothly at the flocculation pH of about 7 to 8. However, since alkalinity of the raw water increases when the algae is flourished, the flocculation reaction does not occur smoothly. However, according to the present invention, the flocculation reaction may be accelerated at low alkalinity because the algae is primarily removed at the settling basin. In addition, an amount of added pH adjuster (carbon dioxide, etc.) for lowering the pH of the raw water may be reduced.

The algae introduced to the precipitation basin 30 has a zeta potential that is lowered during exposed to the high-voltage micro pulse discharge at the settling basin 20. The algae floats in water instead of being precipitated because of repulsion between positive/negative ions of algae particles, and this repulsive force is called as zeta potential. The zeta potential is a key indicator of determining whether a flocculation phenomenon proceeds properly. The high-voltage micro pulse discharge according to the present invention lowers the zeta potential of the algae to accelerate the flocculation reaction caused by the flocculant. Thus, the flocculation reaction of the algae remained in the precipitation basin 30 easily occurs although a small amount of flocculant is added.

The raw water passing through the precipitation basin 30 is introduced into the filtering basin 40. The filtering basin 40 is a space in which micro-floating materials that are not sunken pass through a filter layer such as a sand layer or activated carbon to remove the micro-floating materials.

The raw water passing through the filtering basin 40 is introduced into the disinfection facility 50, and chlorine disinfection is performed to disinfect all sorts of bacteria. When chlorine chemicals are added, a pollutant such as trihalomethane (THM) or microcystine is produced from some kinds of algae. However, the algae treatment device according to the present invention may prevent the above-described pollutant from being produced. That is, secondary pollution is prevented.

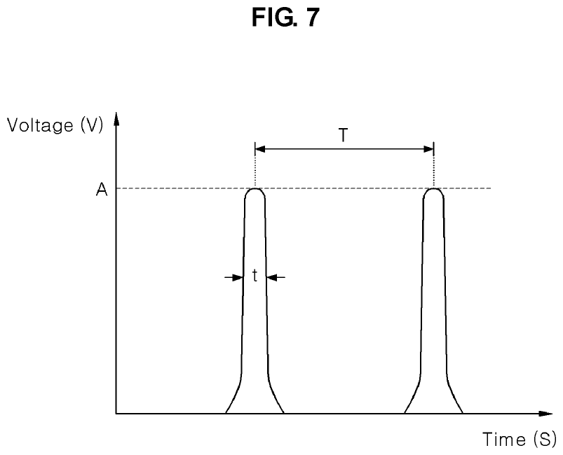

The algae treatment device according to the present invention in FIGS. 1 to 4 uses the high-voltage micro pulse generated from the pulse generation unit 100. Particularly, the high-voltage micro pulse generated from the pulse generation unit 100 of the algae treatment device according to the present invention may have a voltage of 5 kV to 30 kV and a pulse width of 6 μs to 300 μs as in FIG. 7.

Also, thousand times to tens of thousand times of high-voltage micro pulse discharge per one day are required in a process of substantially treating the algae in the waters of interest by using the high-voltage micro pulse. Thus, the pulse generation unit 100 is necessary to stably discharge the high-voltage micro pulse.

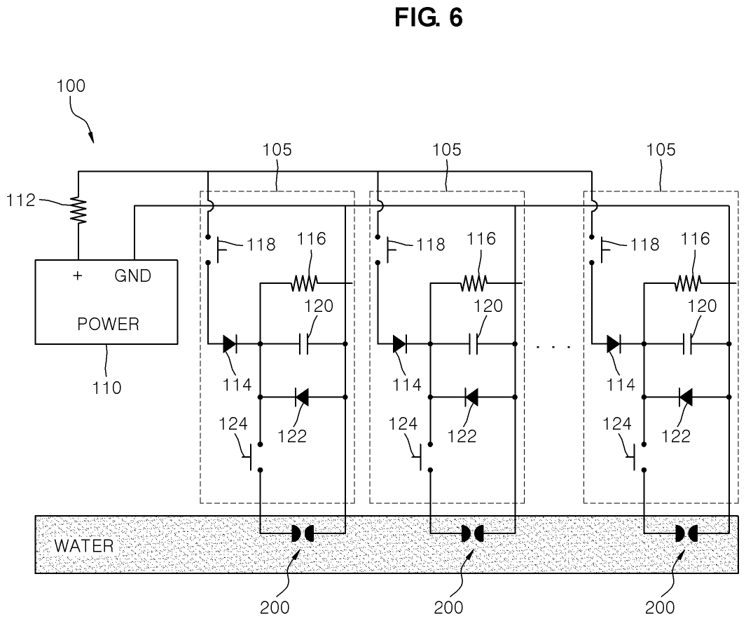

FIG. 6 is a schematic circuit diagram showing a configuration of the algae treatment device according to the present invention.

Referring to FIG. 6, the pulse generation unit 100 includes a power part 110 and a plurality of pulse apply units 105 connected to the power part 110 and generating the high-voltage micro pulse discharge. The power part 110 may provide a DC voltage and, for example, have one terminal grounded and the other terminal providing a power voltage. A charge resistance part 112 for controlling a magnitude of a charge current is installed between the power part 110 and the pulse apply unit 105.

Each pulse apply unit 105 includes a charge switch 118, a charge diode part 114, a charge part 120, a dump resistance part 116, a free wheeling diode 122, and a discharge switch 124. The high-voltage micro pulse generated from the pulse apply unit 105 is discharged through a discharge gap of the front end 200.

The charge part 120 may store a charge voltage by using power inputted from the power part 110 and include at least one capacitor. The charge switch 118 and the charge diode part 114, which are for blocking a surge current, are installed between the power part 110 and the charge part 120. The free wheeling diode part 122 connected in parallel to the charge part 120 operates as a charge switch when the charge part 120 is charged and prevent the charge part 120 from being damaged when the charge part 120 is discharged. The discharge gap of the front end 200, which is connected in parallel to the charge part 120, applies the high-voltage micro pulse into water of waters of interest when the charge part 120 is discharged. The dump resistance part 116 connected in parallel to the charge part 120 forms a discharge path for discharging charges remained in the charge part 120 before and after operation of the charge part 120 for safety. The discharge switch 124 installed between the charge part 120 and the discharge gap of the front end 200 controls discharge.

The charge switch 118 and the discharge switch 124 is alternately turned on and off within one frequency T. For example, when a frequency of the high-voltage micro pulse is 2 seconds, the charge switch 118 charges a voltage to the charge part 120 for about 1.5 seconds in a state in which the charge switch 118 is turned-on, and the discharge switch 124 is turned-off. Thereafter, in a state in which the charge switch 118 is turned-off, and the discharge switch 124 is turned-on, the high-voltage micro pulse discharge is applied through the discharge gap of the front end 200 for 0.5 second.

Although the charge diode part 114 or the free wheeling diode part 122 includes one diode in this embodiment for convenience of description, the present invention is not limited thereto. For example, the charge diode part 114 or the free wheeling diode part 122 may include a plurality of circuit elements to perform the substantially same function. Also, although the charge resistance part 112 or the dump resistance part 116 includes one diode in this embodiment as an example, the present invention is not limited thereto. For example, the charge resistance part 112 or the dump resistance part 116 may include a plurality of circuit elements to perform the substantially same function.

The high-voltage micro pulse generated from the pulse generation unit 100 of the algae treatment device according to the present invention may have a voltage of 5 kV to 30 kV and a pulse width of 6 μs to 300 μs as and stably perform several tens of thousand discharges at the same time.

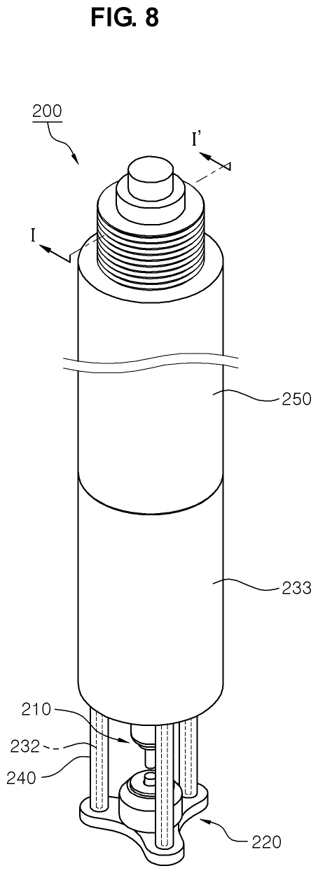

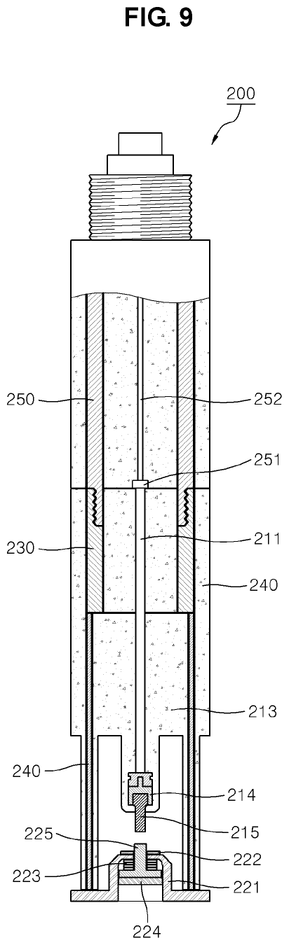

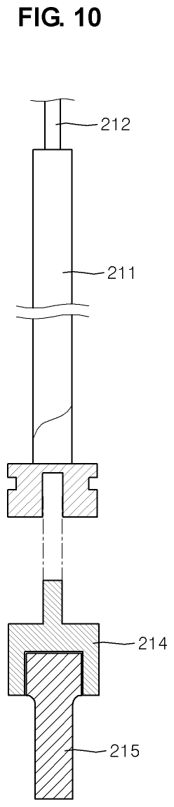

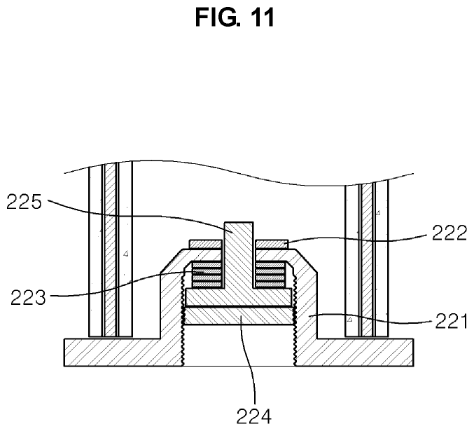

FIG. 8 is a schematic perspective view of a front end of the algae treatment device according to the present invention, FIG. 9 is a schematic cross-sectional view taken along line I-I′ of FIG. 8, FIG. 10 is an exploded cross-sectional view of a positive electrode shaft, a positive electrode chuck, and a positive electrode of the algae treatment device according to the present invention, and FIG. 11 is a schematic cross-sectional view of a negative electrode of the front end of the algae treatment device according to the present invention.

The front end 200 of the algae treatment device according to the present invention will be described with reference to FIGS. 8 to 11.

The front end 200 includes a positive electrode unit 210 and a negative electrode unit 220.

The positive electrode unit 210 is electrically connected to a positive electrode terminal of the pulse generation unit 100. More specifically, a positive electrode 215 is electrically connected to the positive electrode terminal of the pulse generation unit 100. The positive electrode unit 210 includes a positive electrode tip shaft 211 elongated in one direction, a positive electrode chuck 214 detachable to a front portion of the positive electrode tip shaft, a positive electrode 215 fixed by the positive electrode chuck 214, and a positive electrode insulator 213 electrically insulating by surrounding the positive electrode in a state in which one end of the positive electrode is exposed. Here, the positive electrode 215 is welded and fixed to the positive electrode chuck 214.

The positive electrode unit 210 of the front end 200 according to the present invention may easily replace the positive electrode 215 by using the positive electrode chuck 214. As described above, when the algae is treated by the algae treatment device according to the present invention, several thousand times to several tens of thousand times of the high-voltage micro pulse discharge are generated per one day. Although a stable operation is realized through a circuit configuration of the pulse generation unit 100 of the algae treatment device according to the present invention, the electrode is hardly prevented from being worn due to the large number of discharges. Thus, the present invention adds easiness to maintenance in that the worn positive electrode is easily replaced by using the positive electrode chuck 214.

The negative electrode unit 220 is electrically connected to a negative electrode terminal of the pulse generation unit 100. More specifically, a negative electrode 225 is electrically connected to the negative electrode terminal of the pulse generation unit 100. The negative electrode unit 220 is spaced a predetermined distance from the positive electrode unit 210. That is, the negative electrode unit 220 includes a negative electrode jig 221 spaced apart from the positive electrode unit and a negative electrode 225 fixed to be replaceable at a position corresponding to the positive electrode 215 by the negative electrode jig 221. The negative electrode 225 is spaced a predetermined distance from the positive electrode 215, a current flow path caused by plasma through fluid between the positive electrode 215 and the negative electrode 225 is formed. That is, a portion between the positive electrode 215 and the negative electrode 225 is the above-described discharge gap.

The negative electrode jig 221 has a body on which a plurality of legs connected with a return part 232 that will be described later and the negative electrode 225 are installed. As illustrated in FIG. 8, the legs are branched into a plurality of branches by using the body as a center. Here, it is important that an angle between the legs is constant. For example, as illustrated in FIG. 8, an angle between the legs is 120° or 90°. That is, an angle between the legs may be 360°/N (where, N is the number of legs). The negative electrode 225 is inserted to a rear side of a body of the negative electrode jig 221, and the inserted negative electrode 225 has one end exposed to the outside of the body. The one end of the negative electrode 225 is disposed on the same line as one end of the positive electrode 215. The negative electrode 225 is fixed in the body of the negative electrode jig 221 by a press member 224. A distance between the negative electrode 225 and the positive electrode 215 is a key factor for the high-voltage micro pulse discharge. A height adjusting member 223 may be inserted before the negative electrode 225 is inserted into the body to adjust the distance between the negative electrode 225 and the positive electrode 215. Although the height adjusting member 223 may adjust a height by which the negative electrode 225 protrudes to the outside of the body in a method of adjusting the number of a plurality of height adjusting members 223 generated with a unit height, the present invention is not limited thereto. Also, a negative electrode protection member 222 may be installed around a protruding portion of the negative electrode 225. The negative electrode protection member 222 may be made of SUS. In general, the negative electrode unit 220 is damaged by impact generated when the high-voltage micro pulse is discharged between the positive electrode 215 and the negative electrode 225. However, according to the present invention, the negative electrode protection member 222 made of SUS may be disposed around the protruding negative electrode 225 to minimize the damage of the negative electrode unit 220. Also, when the algae is treated by the algae treatment device according to the present invention, several thousand times to several tens of thousand times of the high-voltage micro pulse discharge are generated per one day to cause wear on the negative electrode 225 as well as the positive electrode 215. The present invention adds easiness to the maintenance in that the negative electrode 225 is replaceable by using the negative electrode jig 221 to easily replace the worn negative electrode.

The negative electrode 225 is at least one branch branched and extending from the negative electrode through the negative electrode jig 221 and is connected to the return part 232 that defines a return path of a current. In order to uniformly discharge energy in a forward direction when the high-voltage micro pulse is discharged, a returned current may flow evenly to each of a plurality of return parts 232. Thus, as an angle between all legs of the negative electrode jig 221 of the front end 200 according to the present invention is 360°/N (where, N is the number of legs), a current flowing through the negative electrode 225 is distributed evenly to the plurality of return parts 232 and collected to the pulse generation unit 100. The return parts 232 are surrounded and insulated by the return part insulator 240.

The positive electrode and the negative electrode, each of which has the above-described configuration, may be electrically connected to a cable (not shown) connected with the pulse generation unit 100 by adopting various types of components. In this embodiment, a connector 233, a connection socket 250, and a second connection terminal 251 will be described as an example of the adopted components. The connector 233 is a hollow conductive body, and the plurality of return parts 232 are connected to the connector 233. Also, a thread is formed on an upper inner circumferential surface of the connector 233. As the connector 233 is surrounded by the insulator 240, the connector 233 is electrically insulated. The connection socket 250 serves to electrically connect the negative electrode unit 230 to the cable (not shown) connected with the pulse generation unit 100 through coupling with the connector 233. In this embodiment, as the connection socket 250 is a cylindrical conductive body and has a thread formed on a lower outer circumferential surface thereof, the connection socket 250 is screw-coupled to the connector 233 and electrically connected thereto. A wire 252 connected with the pulse generation unit 100 is disposed at an inner side of the connection socket 250, and the second connection terminal 251 is disposed at a lower end of the wire 252 and coupled with the first connection terminal 212. That is, in this embodiment, the positive electrode 215 is connected with the pulse generation unit 100 through the positive electrode shaft 211, the first connection terminal 212, the second connection terminal 251, the wire 252, and the cable. Also, the negative electrode unit 230 is connected with the pulse generation unit 100 through the connector 233, the connection socket 250, and the cable. In this embodiment, the cable connected with the pulse power system is a coaxial cable. The coaxial cable that is a well-known member includes a hollow outer conductor and an inner conductor disposed inside the outer conductor. Here, the connection socket 250 is connected to the outer conductor, and the wire 252 is connected to the inner conductor.

Also, as a separate front end lifting unit is disposed on the support frame, a worker may easily replace the positive electrode or the negative electrode by lifting the front end when the positive electrode or the negative electrode of the front end is replaced.

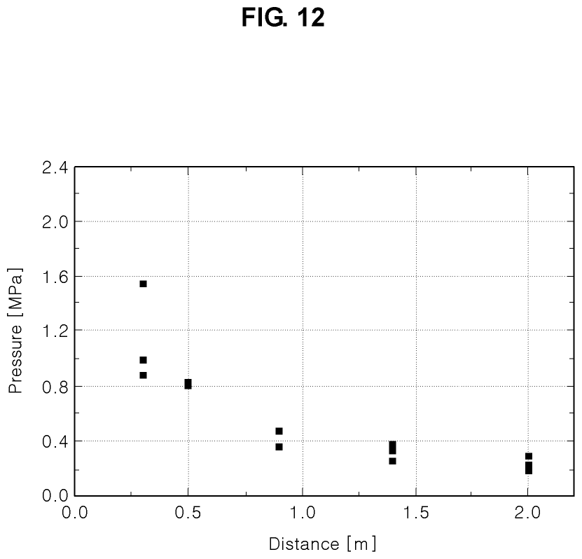

FIG. 12 is a graph obtained by measuring pressure generated based on a distance when the high-voltage micro pulse is discharged in water by using the algae treatment device according to the present invention.

FIG. 12 is a graph obtained by measuring pressure generated when the high-voltage micro pulse is discharged while a pressure sensor moves by a horizontal distance from the discharge gap of the front end 200. A distance of the discharge gap is 3.4 mm, and a voltage is 20 kV.

Referring to FIG. 12, when a horizontal distance of the discharge gap exceeds 100 cm, generated pressure significantly decreases. In order to effectively remove the algae, when the front ends 200 are arranged in a row, a distance between the front ends may be within 50 cm.

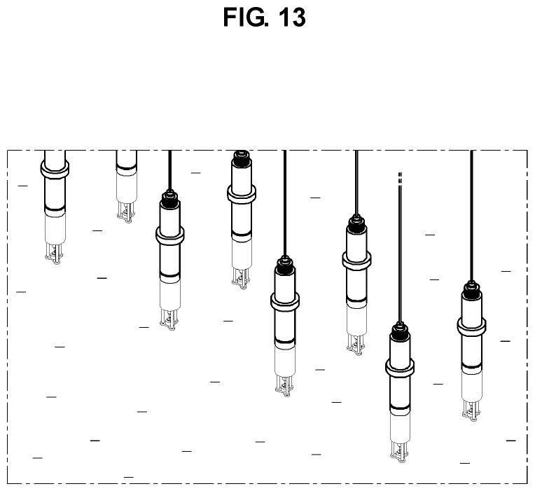

Alternatively, as illustrated in FIG. 13, when the front ends 200 are arranged with two rows or more on the support frame 300, the high-voltage micro pulse is discharged into a spherical area having a radius of about 100 cm, preferably a radius of about 50 cm, by one front end 200. Thus, adjacent rows of the front ends 200 may be alternately arranged. In case of a second row, the front ends 200 are arranged in the form of zigzag.

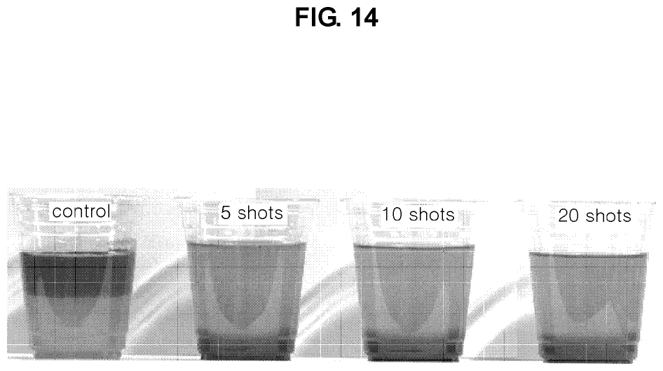

FIG. 14 is a photograph showing an experiment result obtained by discharging the high-voltage micro pulse into water containing the algae by using the algae treatment device according to the present invention.

In this experiment, the high-voltage micro pulse having a voltage of 18 kV and a pulse width of 25 μs is applied with a repetition rate of 0.1 pulse per second (pps). A control shows a case in which the number of discharge is 0, a first experiment group (5 shots) shows a case in which the number of discharge is 5, a second experiment group (10 shots) shows a case in which the number of discharge is 10, and a third experiment group (20 shots) shows a case in which the number of discharge is 20. As illustrated in FIG. 14, the algae exposed to the high-voltage micro pulse discharge according to the present invention may be precipitated under water within a predetermined time even without the flocculant. Although not shown, when the flocculant is added, the algae is further quickly precipitated than a case when the high-voltage micro pulse is not discharged.

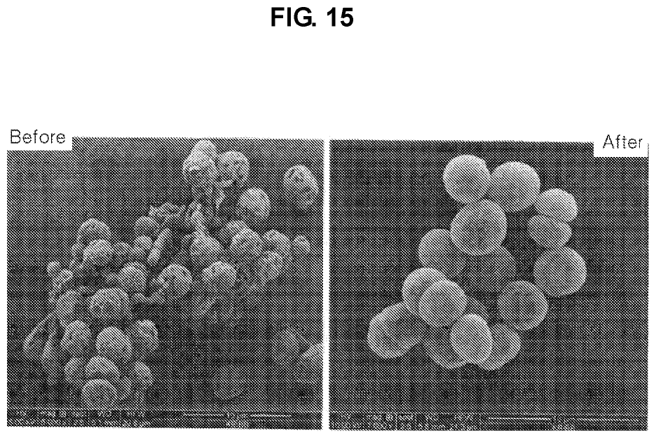

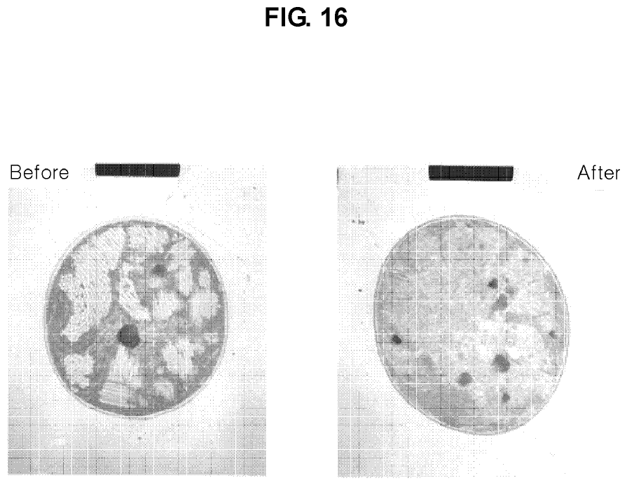

FIG. 15 is a SEM photograph (5000 times magnification) of an algae cell before and after the high-voltage micro pulse is discharged into the water containing the algae by using the algae treatment device according to the present invention, and FIG. 16 is a TEM photograph (15000 times magnification) of an algae cell before and after the high-voltage micro pulse is discharged into the water containing the algae by using the algae treatment device according to the present invention. As shown in FIGS. 15 and 16, when the high-voltage micro pulse is discharged to the algae cell, a cell wall may be maintained as it is although the air-sac of the algae is destroyed.

Also, the preferred embodiments should be considered in descriptive sense only and not for purposes of limitation, and also the technical scope of the invention is not limited to the embodiments. Further, it will be understood that the protective scope of the present invention is not limited by obvious modifications or substitutions in the technical fields of the present invention.

1-8. (canceled)

9. An algae treatment device comprising:
a pulse generation unit configured to generate a high-voltage micro pulse; and
at least one front end connected with the pulse generation unit to discharge the generated high-voltage micro pulse into waters of interest,
wherein the high-voltage micro pulse is discharged to destroy an air-sac of algae in the waters of interest.

10. The algae treatment device of claim 9, wherein the algae treatment device is installed at a water treatment facility.

11. The algae treatment device of claim 9, wherein the pulse generation unit comprises: a charge part configured to receive power from a power part and store a charge voltage; and a free wheeling diode part connected in parallel to the charge part to serve as a charge switch when the charge part is charged and prevent the charge part from being damaged when the charge part is discharged,
the front end comprises a discharge gap connected in parallel to the charge part to discharge a high-voltage micro pulse into the waters of interest when the charge part is discharged, and
a discharge switch configured to control discharge of the high-voltage micro pulse is installed between the discharge gap and the charge part.

12. The algae treatment device of claim 11, wherein a charge diode part for blocking a surge current is installed between the charge part and the power part, and the charge diode part and the discharge switch are alternately turned-on and off within one frequency.

13. The algae treatment device of claim 9, wherein the high-voltage micro pulse generated from the pulse generation unit has a voltage of 5 kV to 30 kV and a pulse width of 6 ρs to 300 μs.

14. The algae treatment device of claim 9, further comprising a support frame on which a front end wire configured to connect the front end and the pulse generation unit is held and which allows the front end to maintain a predetermined depth in the waters of interest.

15. The algae treatment device of claim 14, wherein a plurality of front ends are installed elongated in one direction on the support frame or are arranged with two rows or more in one direction on the support frame, so that front ends of adjacent rows are alternately installed.

16. The algae treatment device of claim 14, further comprising a front end lifting unit installed on the support frame to adjust a height of the front end.

17. The algae treatment device of claim 9, wherein the front end comprises:
a positive electrode unit comprising a positive electrode tip shaft elongated in one direction, a positive electrode chuck detachable to a front portion of the positive electrode tip shaft, a positive electrode electrically connected with a positive electrode terminal of the pulse generation unit and fixed by the positive electrode chuck, and a positive electrode insulator configured to electrically insulate the positive electrode by surrounding the positive electrode in a state in which one end of the positive electrode is exposed;
a negative electrode unit comprising a negative electrode jig spaced apart from the positive electrode unit and a negative electrode fixed to be replaceable at a position corresponding to the positive electrode by the negative electrode jig and electrically connected with a negative electrode of the pulse generation unit to define a current flow path; and
a return part comprising at least one branch branched and extending from the negative electrode to define a return path of a current.

18. A water treatment method using an algae treatment device comprising a pulse generation unit configured to generate a high-voltage micro pulse and at least one front end connected with the pulse generation unit to discharge the generated high-voltage micro pulse into waters of interest, wherein the high-voltage micro pulse is discharged to destroy an air-sac of algae in the waters of interest, so that the algae is precipitated.

19. The water treatment method of claim 18, wherein the algae in which the air-sac is destroyed is flocculated and precipitated to be separated from raw water by adding a flocculant after the high-voltage micro pulse is discharged.

20. The water treatment method of claim 19, wherein the high-voltage micro pulse is discharged at a settling basin of a water treatment facility, and the flocculant is added at a precipitation basin of the water treatment facility.
